(19) United States
(12) Patent Application Publication
(10) Pub. No.: US 2026/0141041 A1
(43) Pub. Date: May 21, 2026

(54) ZERO-TRUST WEB SESSION CACHING

(71) Applicant: Raytheon Company, Tewksbury, MA (US)

(72) Inventors: Benjamin C. Churchill, Spokane, WA (US); Nicholas W. Barrett, Oro Valley, AZ (US)

(21) Appl. No.: 18/949,915

(22) Filed: Nov. 15, 2024

(51) Int. Cl. G06F 21/31

(52) U.S. Cl. CPC G06F 21/31

(57) ABSTRACT

Devices, systems, machine-readable media, and methods for web session caching with improved security are provided. A method can include receiving, at the multi-tenant cache and from a web-based client, a first request to perform an operation on web session data in the multi-tenant cache, issuing, by the multi-tenant cache, a validation request to an authorization service, receiving, by the multi-tenant cache, a result of the validation request, responsive to determining the result of the validation request is a valid verification, performing the operation on the multi-tenant cache, and issuing, by the multi-tenant cache and to the web-based client, a response to the first request.

### TECHNICAL FIELD

Embodiments discussed herein regard devices, systems, machine-readable media and methods in the field of web session caching. Embodiments regard zero-trust web session caching. Some embodiments regard three-dimensional (3D) web session caching.

### BACKGROUND

Web session caching is a combination of web caching and web session management that can improve the performance of an application and enable improved availability.

### BRIEF DESCRIPTION OF THE DRAWINGS

FIG. 1 illustrates, by way of example, a flow diagram of an embodiment of a method for improved security in web data management and web application availability.

FIG. 2 illustrates, by way of example, a diagram of an embodiment of a system for improved web session caching.

FIG. 3 illustrates by way of example, a flow diagram of an embodiment of a method 300 for web session caching with improved security.

FIG. 4 illustrates generally an example of a block diagram of a machine upon which any one or more of the techniques discussed herein can perform in accordance with at least one example of this disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Many application providers provide access to their application through the internet. Availability is a necessity for many of these application providers. The goal of availability is to allow the application to operate continuously and without access interruption. At the same time, it is important that an application development team is allowed to push out a new release of the application, such as to fix a bug, improve security, alter operation of the application, or the like.

For an application to be available, redundancy of application instances and crossover of application sessions are both, individually or in combination, helpful. Having multiple instances of a system or data (redundancy) can eliminate single points of failure in the case of some malfunction, attack, or external event. But at the same time, all redundant deployments of systems need to be replaced with updated deployments to complete patches or updates. Reliable crossover ensures this process goes smoothly.

For a given web session, such as a web session that is managed using the hypertext transfer protocol (HTTP), sensitive user data, along with other data, is stored as web session data. The web session data can be stored across redundant components. The web session data benefits from being persisted between deploys.

Multi-tenant applications have an additional security concern of keeping data logically separated. A first tenant of the application provider should not be able to access a web session belonging to a different, second tenant, of the application provider.

Embodiments provide methods, devices, systems, machine-readable media, or the like that implement redundancy and reliable crossover for multi-tenant web-based clients. Multi-tenant applications have logical separations of data based on the currently authenticated user. Data in one tenant needs to be kept logically separate from data of other tenants.

High availability with web-based clients can be difficult due to the fact that web session data is generated using a stateless protocol. Web sessions and cookies store information that are to be remembered across multiple stateless web requests, but sessions are stored on the server due to their holding sensitive information (e.g., authentication information or the like). When new instances of the server holding the web session data are deployed, those previously existing web sessions are lost (by not being propagated to the new server). Thus, availability of the web application benefits from having access to this sensitive information. For this access, the sensitive information can be distributed and retained to support more highly available web clients. Embodiments provide an architecture that enables redundancy and reliable crossover for web-based clients by supporting multi-tenanted remote caching of web session data.

Improvements provided by embodiments include the manner of handling security and storage of remotely cached web sessions. Regarding the security of remotely caching web sessions, the web sessions can contain sensitive information and the web session data includes this sensitive information and needs to be managed securely. “Securely” means in a manner that the web session data is not retrievable for anyone other than the user (and user device) that generated the data. This is generally trivial for local caching and single-tenant, remote caching is a well-explored problem. However, in multi-tenant systems with distributed redundancy where multiple instances of an application need to access sessions, security becomes much more difficult.

Embodiments introduce an authorization application programming interface (API) to implement zero-trust caching. The authorization API uses Hash-Based Message Authentication Code (HMAC) signatures to ensure 1) the client system’s identity (authentication), 2) the given tenant has permissions to operate on the cache (authorization), and 3) the request has not been tampered with. This ensures that every request is authorized and authenticated per tenant even if the user and client system have been previously authorized and authenticated to perform an operation using the web-based client. This is novel to do for caching, as caches are optimized for speed rather than security. However, given the nature of the problem and the ability to also locally cache sessions, the reduction in speed, for the increased security, is justifiable.

Regarding storage, recall that the web session caching is occurring in the context of a system with redundancy, so there are multiple instances of the same application using the cache. Because sessions belong to both an application and tenant, they need to be only visible to the originating application on behalf of the particular tenant. For security purposes, it is important that a first tenant is not able to retrieve a session meant for a second tenant, even if the same application requests it. To prevent this, storage of web session data is separated by both tenant and application. This effectively results in a 3-dimensional cache that keeps sensitive data from mingling upon three axes: application identification, tenant identification, and session identification.

Separating data by both the tenant and the application is new, as caches are typically single-dimensional – only indexing data by a single identification value. While these “flat-cache” approaches are applicable in the context of redundant, multi-tenant systems, it is not sufficiently secure as sensitive session data is mingling in the same store with no distinctions of external ownership. The novel 3-dimensional storage keeps sensitive session data secure and auditable, as it requires client devices to provide three keys (e.g., identification values) rather than just one.

Further security and efficiency can be provided by limiting a local cache and a remote cache to store only web session data. Caches are typically used to store arbitrary data. But the focus on only storing sessions allows the architecture to be more secure and efficient for the concrete problem at hand.

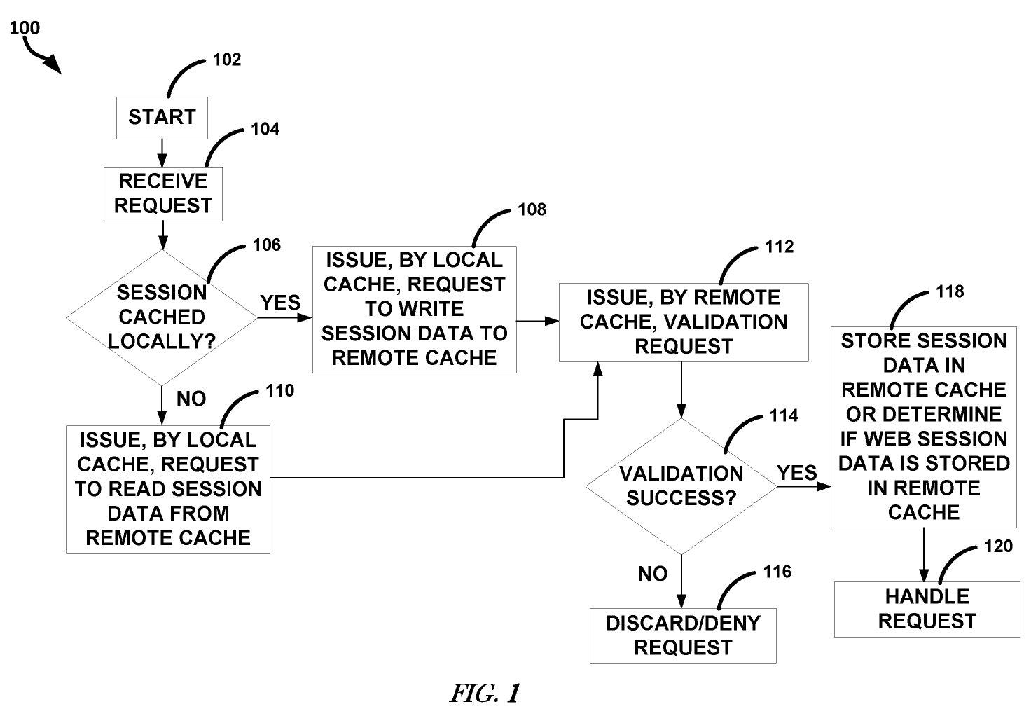

FIG. 1 illustrates, by way of example, a flow diagram of an embodiment of a method 100 for improved security in web data management and web application availability. The method 100 as illustrated includes beginning at operation 102. At operation 104 a web request is received. The request can be in HTTP or other stateless web session format. The request can include information, such as a universal resource identifier (URL), target endpoint path, a query string, a protocol version, or the like. The request, in the case of an HTTP request can include a request line, a header, and a body. The request line includes the HTTP method (an action to be performed), the resource being requested, and the protocol version. The header includes metadata about the message, and the body includes the data to be provided to the server.

At operation 106, a web server that executes a web-based client determines whether a web session indicated in the request is cached locally. Locally, in this context, means on the same network as the web server. Within the same network, there is no firewall between the web server and the local cache. If the web session is determined to be cached locally at operation 106, the local cache issues a request to write the session data to a remote cache, at operation 108. Note that a cache includes more than just a memory and a controller. The cache also includes a network interface card (NIC) and corresponding interface circuitry to issue requests to a network and receive and process the responses to the request. The cache can interface with another cache, an API, web servers, a combination thereof, or the like.

If the web session is determined to not be cached locally at operation 106, the local cache issues a request to read the session data from the remote cache, at operation 110. Regardless of whether the web session data was stored locally or not, at operation 112, the remote cache issues a validation request to an authorization API. The request can include an HMAC signature (or other signature), the web session ID, an application ID, and a tenant ID.

The HMAC signature can be generated by combining attributes of the request received at operation 104 and hashing one or more portions of the request using one or more of several eligible hashing algorithms. The HMAC signature can be generated based on one or more HTTP headers. The HMAC signature can then be analyzed for indicators of data security and classification for authorization purposes. Additional metadata can be used to ensure signature uniqueness of the HMAC signature and one-time use.

HMAC signatures can be generated from any defined message. In most implementations for web-based API systems, information about the HTTP request can be used to generate the HMAC signature, such as the uniform resource locator (URL), HTTP method, timestamp, and unique salting values. HMAC signatures use secret key material and a hash function to create a unique signature, known as a hashed message authentication code (HMAC). The signature can be authenticated and verified by the authorization service by recreating the same hash with the secret key material. This is a powerful and efficient method to provide authentication and authorization controls and minimizes the risk of secret key material being transferred between systems, even in encrypted form.

HMACs are fast and can be applied to data, such as web application programing interfaces (APIs), or other sensitive data payloads, such as financial, healthcare, security, or other personally identifiable information. Because HMACs use symmetric cryptography, the performance is faster and can use a variety of one-way hashing algorithms, providing different levels of security and performance. The technique of using HMACs is common throughout industry and is used to provide security for several Internet standards and communication protocols, including JavaScript Object Notation (JSON) Web Tokens (JWT).

The authorization API receives the request from the remote cache. Each request to read or write from or to the remote cache can be verified by a request to the authorization service and from the remote cache. The authorization service verifies that the tenant is allowed to access the application based on the HMAC signature. The authorization service indicates whether the tenant is authorized to perform the read or write to the remote cache.

At operation 114, the authorization API, determines whether the request is valid. If the request is not valid, the authorization API indicates this to the remote cache. An invalid request is one for which the authorization API determines that the user (in the context of the tenant) indicated by the request is not authorized to perform the operation indicated by the request issued at operation 108 or 110. Responsive to receiving the indication of an invalid request from the authorization API, the remote cache discards the request at operation 116 and issues a result to the local cache indicating that the request was invalid. If the request is valid, the authorization API indicates this to the remote cache. Responsive to receiving the indication that the request is valid, the remote cache determines if the web session data associated with the web session is stored in the remote cache (in the case of a read request) (operation 110), or stores the session data in the remote cache (in the case of a write request (operation 108). In the case of determining whether the web session data is stored in the remote cache, the remote cache makes the determination and either (i) provides the web session data to the local cache if the web session data is present or (ii) indicates a miss to the local cache if the web session data is present.

At operation 120, the web service receives the results from the operation 118 and continues to handle the web application request accordingly. The operation 120 can include re-loading a web session based on authentication information provided a web session that was previously disconnected. The operation 120 can include prompting, by the web application, the tenant for authentication information if the web session data was not found in either of the local cache or the remote cache.

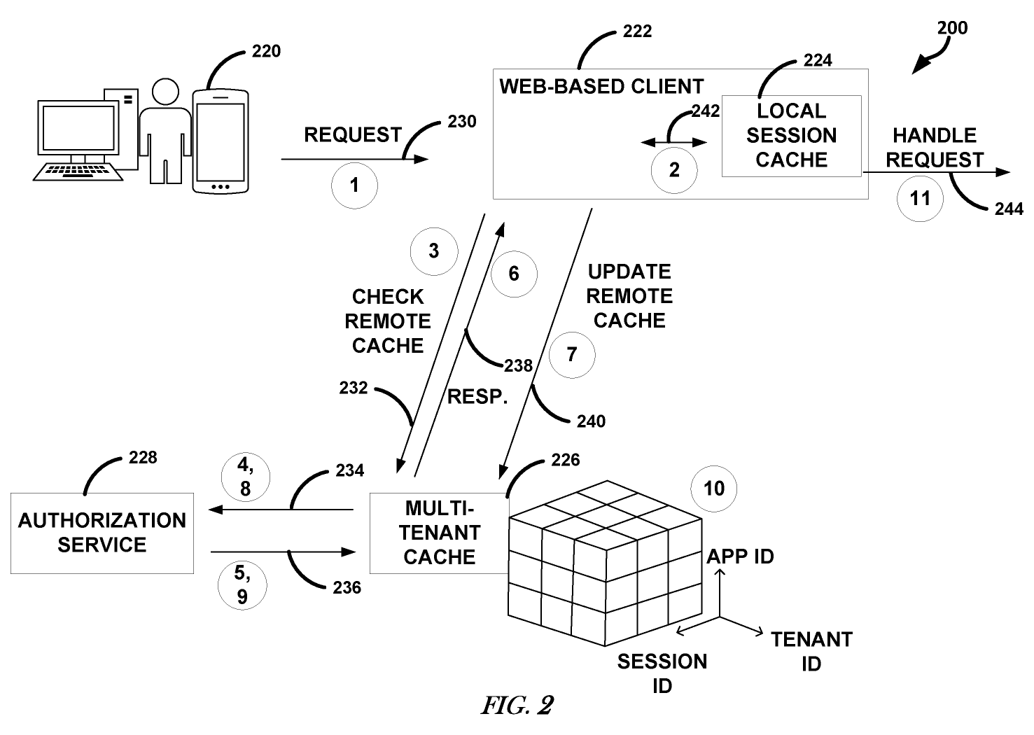

FIG. 2 illustrates, by way of example, a diagram of an embodiment of a system 200 for improved web session caching. The system 200 as illustrated includes a client device 220 communicatively coupled to a web-based client 222, such as through a network interface. The web-based client 222 provides access to functionality of an application, storage device, or the like. The web-based client 222 is communicatively coupled to both a local session cache 224, and a multi-tenant cache 226. The multi-tenant cache 226 is communicatively coupled to an authorization service 228.

The client device 220 includes any device capable of coupling to the web-based client 222. The client device 220 can include a smartphone or other phone, laptop, desktop, or other computer, a smartwatch, or other device capable of communicatively coupling to the web-based client 222. The client device 220 can establish a web session through the web-based client 222. The web session can include access to a web-based application, a cloud resource, or the like. The client device 220 can issue a request 230 to the web-based client 222. The request 230 can include an action, a source address that indicates the client device 220, a destination address that indicates a target of the action, a payload, metadata, a combination thereof, or the like. Commonly, the request 230 conforms with HTTP, HTTP secure (HTTPS), or another web-based communication protocol format.

The web-based client 222 can be hosted on a web server. The web-based client 222 provides access to functionality of an application, device, or other compute resource. A web session can be established between the client device 220 and the web-based client 222. In many instances, the web session proceeds with the client device 220 providing authentication information to the web-based client 222. The veracity of the authentication information is verified by the web-based client 222, usually by consulting an authorization service (same or different as the authorization service 228). If the authentication information is successfully verified and the client is authorized to access the functionality of the web-based client 222, the web-based client 222 stores web session data in the local session cache 224. The web session data can include authentication information and other metadata (e.g., client device identification (ID), timestamp, tenant ID, application ID, resource ID, a combination thereof, or the like).

The local session cache 224 is stored locally to the web-based client 222 and is dedicated to serving only the web-based client 222. The local session cache 224 can purge records stored thereon for a specified period of time. The cache 224 is thus a temporary storage location. The cache 224 typically stores data that might be used in the near future by the web-based client 222. In some instances, the cache 224 serves only the web-based client 222 and only services a single tenant. In some instances the local cache 224 can serve multiple tenants, in which case it would either mingle session data of multiple tenants and include logic to separate the data in a one-dimensional or two-dimensional cache. Alternatively, the system 200 can include multiple local caches, one for each tenant. Yet another alternative is to have one deployment of the web-based client per tenant - each of which has their own local cache.

The web-based client 222 can check the local session cache 224 for an entry associated with the web session. If the entry is present in the local session cache 224, the web-based client 222 can retrieve the web session data and provide the web session data to the client device 220 based on the web session data. If, however, the web session data is not present on the local session cache 224, the web-based client 222 can attempt to retrieve the web session data from the multi-tenant cache 226.

The multi-tenant cache, as it name suggests, stores web session data for multiple tenants. A tenant is a distinct individual, group, department, or company that has authority to access cloud computing services. A given tenant is not authorized to access web sessions or web session data of a different tenant. Co-mingling web session data from multiple tenants on a given multi-tenant cache creates a security risk that a first tenant will attempt to access a web session started by a second, different, tenant.

To help reduce or eliminate the security threat created by a multi-tenant cache, the system 200 includes an authorization service 228 communicatively coupled to the multi-tenant cache 226. The authorization service 228 verifies whether a given client device has authorization to perform an operation indicated in a request to the multi-tenant cache 226. To establish zero-trust principles, for every request received by the multi-tenant cache 226, the multi-tenant cache 226 can verify, by consulting the authorization service 228, that the request is associated with an authorized web session.

The authorization service 228 can verify an HMAC signature is associated with a given tenant ID and an application ID. Thus, a request 232, 240 to the remote multi-tenant cache 226 can include this information, or can include information by which the multi-tenant cache 226 can determine one or more of the HMAC signature, tenant ID, application ID, or a combination thereof. The authorization service 228 provides the multi-tenant cache 226 with data indicating a result of the attempted verification.

If the verification is successful, the multi-tenant cache 226 attempts to perform the action indicated in the request 232, 240. The request 232 is a read request, so the multi-tenant cache 226 attempts to retrieve web session data indicated in the request 232. The request 240 is a write request, so the multi-tenant cache 226 stores the web session data from the request 240 in the multi-tenant cache 226. The multi-tenant cache 226 provides the result of the read in a response 238. If the response 238 indicates that the web session data is not present in the multi-tenant cache 226, the web-based client 222 will make the client device 220 re-authenticate with the web-based client 222 to re-establish connection. If the response 238 indicates that the web session data is present in the multi-tenant cache 226, the web-based client 222 will use the web session data from the multi-tenant cache 226 to re-establish the web session.

The multi-tenant cache 226 can be configured to segregate web session data in a way that is more secure than current web session data caches. Current web session data caches store web session data linearly in a sort of two-dimensional (2D) row and column form. The multi-tenant cache 226, in contrast, stores the web session data in a 3D row, column, and width (sometimes called a “page”) form. The row, column, and width can each correspond to one of a tenant ID, application ID, or a session ID. After the web session data is retrieved by the web-based client 222, the web-based client 222 handles the operation 244 indicated by the request 230.

As discussed, sometimes a web session is interrupted or otherwise disconnected. The web session contains information based on the cookie stored on the client device. When the client device 220 is disconnected and the cookie from an earlier session is reintroduced, if the session has not timed out, the cookie will be used to retrieve the authenticated session and resume the interaction with the web-based client 222.

Sometimes, responsive to the web session being interrupted, the client device 220 attempts to re-establish the web session connection with the web-based client 222. The web-based client 222 can, instead of re-validating the client device 220, retrieve prior web session data that is stored in either the local session cache 224 or the multi-tenant cache 226. The web session data can include authentication information that can be used to verify that the client device 220 is authorized to perform the operation indicated by the request 230. However, the web-based client 222 can have access to the multi-tenant cache 226 that includes data for multiple tenants that access the functionality of the web-based client 222 (or another instance of the web-based client).

To help prevent man-in-the-middle attacks, or other potential attacks, the authorization service 228 is communicatively coupled to the multi-tenant cache 226. The multi-tenant cache 226 is configured to, for each request 232, 240 verify the veracity of the request through the authorization service 228. The multi-tenant cache 226 thus verifies that the request 230 is associated with a valid, authorized request and guarantees that the user is allowed to access and perform the operation indicated in the request 230 before the multi-tenant cache 226 responds to the web-based client 222. The authorization service 228 prevents session jacking via interception-based attacks via the HMAC signature so that the session cannot be hijacked from the remote cache 226. The authorization service 228 performs bidirectional integrity checks on HMAC signatures; the original request and then the receipt are also signed and verified. This means that the requestor is confirmed to have possession of the secret key(s) and the request or response is less likely to have been intercepted or tampered with.

While the authorization service 228 slows down the throughput of the multi-tenant cache 226, it provides security for the cloud data stored in the multi-tenant cache.

There are multiple flows indicated by the circled numbers in FIG. 2. The flows can proceed as follows:

1: issuing, by the client device 220, a request 230 to perform a web session operation and receiving the request 230 at the web-based client 222.

2: issuing, by the web-based client 222, a request 242 to read the web session data on the local session cache 224 and providing a result, either the web session data or an indication that the web session data is not present.

3: if the local session cache 224 does not have the web session data, issuing the request 232 to read the web session data from the multi-tenant cache 226 and receiving the request 232 at the multi-tenant cache 226.

4: issuing, by the multi-tenant cache 226, the request 234 to verify that the user of the client device 220 is authorized to read the web session data and receiving the request 234 at the authorization service 228.

5: issuing, by the authorization service 228, a result 236 of the request 234 and receiving the result 236 at the multi-tenant cache 226.

6: if the result 236 indicates that the user is authorized to read the web session data, the multi-tenant cache 226 attempts to read the web session data from the multi-tenant cache 226. If the read is successful, the multi-tenant cache 226 issues the response 238 including the web session data. If the read is unsuccessful or the authorization at the authorization service 228 failed, the response 238 indicates that the web session data is not available.

7: After the web session has been established (whether through cache retrieval or creation), the web-based client 222 can attempt to write any modified web session data to the multi-tenant cache 226, so as to provide a backup of the web session data. The web-based client 222 issues a write request 240 to the multi-tenant cache 226.

8: same as 4 except for writing the web session data to the multi-tenant cache 226.

9: same as 5 except regarding the write request issued at 7.

10: multi-tenant cache 226 can be 3D, indexing entries by a triplet of (application ID, session ID, tenant ID). The multi-tenant cache 226 can lookup web session data based on the triplet or store data indexed by the triplet.

11: the web-based client 222 handles the request at operation 244. The web-based client 222 can either attempt to begin a new web session, provide a continuation of a prior web session, or deny a request associated with a web session.

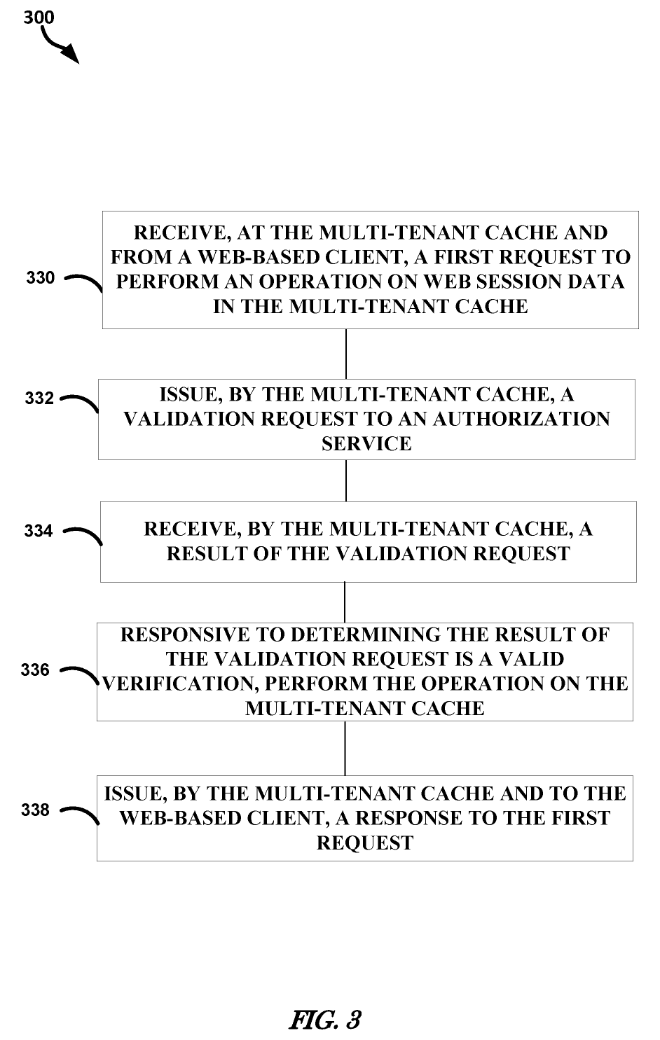

FIG. 3 illustrates by way of example, a flow diagram of an embodiment of a method for web session caching with improved security. The method 300 as illustrated includes receiving, at the multi-tenant cache and from a web-based client, a first request to perform an operation on web session data in the multi-tenant cache, at operation 330; issuing, by the multi-tenant cache, a validation request to an authorization service, at operation 332; receiving, by the multi-tenant cache, a result of the validation request, at operation 334; responsive to determining the result of the validation request is a valid verification, performing the operation on the multi-tenant cache, at operation 336; and issuing, by the multi-tenant cache and to the web-based client, a response to the first request, at operation 338.

The validation request can include a hash-based signature of credentials, a tenant identification (ID), an application ID, or a combination thereof. The first request can include a hash-based signature of credentials, a tenant identification (ID), an application ID, a web session ID, a payload for an application associated with the application ID, or a combination thereof.

The multi-tenant cache can be indexed by a triplet including application identification (ID), tenant ID, and session ID. The multi-tenant cache can issue the validation request to the authorization service for every request received at the multi-tenant cache.

The response can include the web session data for the web session uniquely identified by an application identification (ID), tenant ID, and session ID. The method 300 can further include, before receiving the first request, receiving, at a web-based client, a request to re-initiate a web session that was previously disconnected.

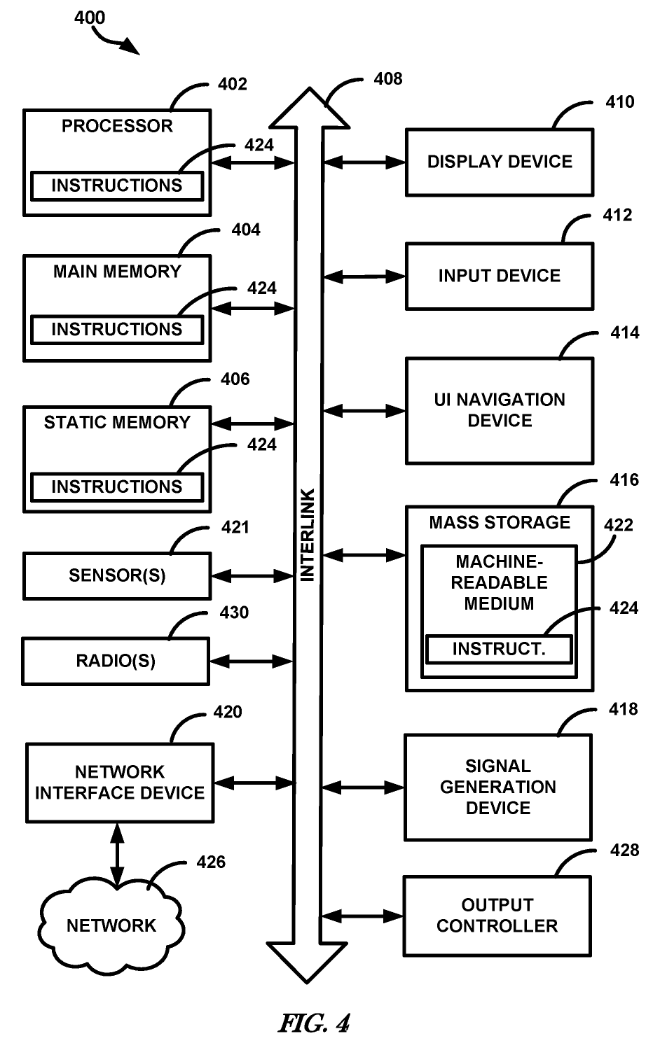

FIG. 4 illustrates generally an example of a block diagram of a machine upon which any one or more of the techniques discussed herein can perform in accordance with at least one example of this disclosure. A variety of operations, methodologies, or processes described herein may be executed, implemented or performed by one or more of the components of the computer system 400, for example, can be used to implement or provide the functionality of one or more of the operations 104, 106, 108, 110, 112, 114, 116, 118, 120, the client device 220, the web-based client 222, the local session cache 224, the multi-tenant cache 226, the authorization service 228, or the method 300. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

This example machine can operate some or all of quality assurance system discussed herein. In some examples, the quality assurance system can operate on the example machine 400. In other examples, the example machine 800 is merely one of many such machines used to operate the quality assurance system. In alternative embodiments, the example machine 400 can operate as a standalone device or can be connected (e.g., networked) to other machines. In a networked deployment, the example machine 400 can operate in the capacity of a server machine, a client machine, or both in server-client network environments. In an example, the example machine 400 can act as a peer machine in peer-to-peer (P2P) (or other distributed) network environment. The example machine 400 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term "machine" shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 400 can include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The example machine 400 can further include a display device 410, an alphanumeric input device 412 (e.g., a keyboard), and a user interface UI navigation device 414 (e.g., a mouse). In an example, the display device 410, input device 412 and UI navigation device 414 can be a touch screen display. The 400 can additionally include a storage device 416 (e.g., drive unit), a signal generation device 418 (e.g., a speaker), a network interface device 420, and one or more sensors 421, such as a global positioning system (GPS) sensor, compass, accelerometer, or other sensor. The 400 can include an output controller 428, such as a serial (e.g., Universal Serial Bus (USB), parallel, or other wired or wireless (e.g., infrared (IR), near field communication (NFC), etc.) connection to communicate or control one or more peripheral devices (e.g., a printer, card reader, etc.).

The storage device 416 can include a machine readable machine-readable medium 422 on which is stored one or more sets of data structures or instructions 424 (e.g., software) embodying or utilized by any one or more of the techniques or functions described herein. The instructions 424 can also reside, completely or at least partially, within the main memory 404, within static memory 406, or within the hardware processor 402 during execution thereof by the 400. In an example, one or any combination of the hardware processor 402, the main memory 404, the static memory 406, or the storage device 416 can constitute machine readable media.

While the machine-readable medium 422 is illustrated as a single medium, the term "machine readable medium" can include a single medium or multiple media (e.g., a centralized or distributed database, or associated caches and servers) configured to store the one or more instructions 424. The term "machine readable medium" can include any medium that is capable of storing, encoding, or carrying instructions for execution by the 400 and that cause the 400 to perform any one or more of the techniques of the present disclosure, or that is capable of storing, encoding or carrying data structures used by or associated with such instructions. Non-limiting machine-readable medium examples can include solid-state memories, and optical and magnetic media.

The instructions 424 can further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 702.11 family of standards known as Wi-Fi®, IEEE 702.16 family of standards known as WiMax®), IEEE 702.15.4 family of standards, peer-to-peer (P2P) networks, among others. In an example, the network interface device 420 can include one or more physical jacks (e.g., Ethernet, coaxial, or phone jacks) or one or more antennas to connect to the communications network 426. In an example, the network interface device 420 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the 400, and includes digital or analog communications signals or other intangible medium to facilitate communication of such software.

### Examples and Additional Notes

Example 1 includes a method for multi-tenant cache operations, the method comprising receiving, at the multi-tenant cache and from a web-based client, a first request to perform an operation on web session data in the multi-tenant cache, at operation 330; issuing, by the multi-tenant cache, a validation request to an authorization service, at operation 332; receiving, by the multi-tenant cache, a result of the validation request, at operation 334; responsive to determining the result of the validation request is a valid verification, performing the operation on the multi-tenant cache, at operation 336; and issuing, by the multi-tenant cache and to the web-based client, a response to the first request, at operation 338.

In Example 2, Example 1 further includes, wherein the validation request includes a hash-based signature of credentials, a tenant identification (ID), and an application ID.

In Example 3, at least one of Examples 1-2 further includes, wherein the first request includes a hash-based signature of credentials, a tenant identification (ID), an application ID, a session ID if authenticated, and a payload for an application associated with the application ID.

In Example 4, at least one of Examples 1-3 further includes, wherein the multi-tenant cache is indexed by a triplet including application identification (ID), tenant ID, and session ID.

In Example 5, at least one of Examples 1-4 further includes, wherein the multi-tenant cache issues the validation request to the authorization service for every request received at the multi-tenant cache.

In Example 6, at least one of Examples 1-5 further includes, wherein the response includes the web session data for the web session uniquely identified by an application identification (ID), tenant ID, and session ID.

In Example 7, at least one of Examples 1-6 further includes, before receiving the first request, receiving, at a web-based client, a request to re-initiate a web session that was previously disconnected.

Example 8 includes a non-transitory machine-readable medium including instructions that, when executed by a machine, cause the machine to perform operations for multi-tenant web session caching, the operations comprising receiving, at the multi-tenant cache and from a web-based client, a first request to perform an operation on web session data in the multi-tenant cache, issuing, by the multi-tenant cache, a validation request to an authorization service, receiving, by the multi-tenant cache, a result of the validation request, responsive to determining the result of the validation request is a valid verification, performing the operation on the multi-tenant cache, and issuing, by the multi-tenant cache and to the web-based client, a response to the first request.

In Example 9, Example 8 further includes, wherein the validation request includes a hash-based signature of credentials, a tenant identification (ID), and an application ID.

In Example l0, at least one of Examples 8-9 further includes, wherein the first request includes a hash-based signature of credentials, a tenant identification (ID), an application ID, a session ID if authenticated, and a payload for an application associated with the application ID.

In Example 11, at least one of Examples 8-10 further includes, wherein the multi-tenant cache is indexed by a triplet including application identification (ID), tenant ID, and session ID.

In Example 12, at least one of Examples 8-11 further includes, wherein the multi-tenant cache issues the validation request to the authorization service for every request received at the multi-tenant cache.

In Example 13, at least one of Examples 8-12 further includes, wherein the response includes the web session data for the web session uniquely identified by an application identification (ID), tenant ID, and session ID.

In Example 14, at least one of Examples 8-13 further includes, wherein the operations further comprise, before receiving the first request, receiving, at a web-based client, a request to re-initiate a web session that was previously disconnected.

Example 15 includes a system for web session caching, the system comprising a web-based client configured to issue a first request to perform an operation on web session data, and a multi-tenant cache configured to receive the first request, issue a validation request to an authorization service, receive, from the authorization service, a result of the validation request, responsive to determining the result of the validation request is a valid verification, performing the operation on the web session data, and issue to the web-based client, a response to the first request.

In Example 16, Example 15 further includes, wherein the validation request includes a hash-based signature of credentials, a tenant identification (ID), and an application ID.

In Example 17, at least one of Examples 15-16 further includes, wherein the first request includes a hash-based signature of credentials, a tenant identification (ID), an application ID, a session ID if authenticated, and a payload for an application associated with the application ID.

In Example 18, at least one of Examples 15-17 further includes, wherein the multi-tenant cache is indexed by a triplet including application identification (ID), tenant ID, and session ID.

In Example 19, at least one of Examples 15-18 further includes, wherein the multi-tenant cache issues the validation request to the authorization service for every request received at the multi-tenant cache.

In Example 20, at least one of Examples 15-19 further includes, wherein the response includes the web session data for the web session uniquely identified by an application identification (ID), tenant ID, and session ID.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for multi-tenant cache operations, the method comprising:
receiving, at the multi-tenant cache and from a web-based client, a first request to perform an operation on web session data in the multi-tenant cache;
issuing, by the multi-tenant cache, a validation request to an authorization service;
receiving, by the multi-tenant cache, a result of the validation request;
responsive to determining the result of the validation request is a valid verification, performing the operation on the multi-tenant cache; and
issuing, by the multi-tenant cache and to the web-based client, a response to the first request.

2. The method of claim 1, wherein the validation request includes a hash-based signature of credentials, a tenant identification (ID), and an application ID.

3. The method of claim 1, wherein the first request includes a hash-based signature of credentials, a tenant identification (ID), an application ID, a session ID, and a payload for an application associated with the application ID.

4. The method of claim 1, wherein the multi-tenant cache is indexed by a triplet including application identification (ID), tenant ID, and session ID.

5. The method of claim 1, wherein the multi-tenant cache issues the validation request to the authorization service for every request received at the multi-tenant cache.

6. The method of claim 1, wherein the response includes the web session data for the web session uniquely identified by an application identification (ID), tenant ID, and session ID.

7. The method of claim 1, further comprising, before receiving the first request, receiving, at a web-based client, a request to re-initiate a web session that was previously disconnected.

8. A non-transitory machine-readable medium including instructions that, when executed by a machine, cause the machine to perform operations for multi-tenant web session caching, the operations comprising:
receiving, at the multi-tenant cache and from a web-based client, a first request to perform an operation on web session data in the multi-tenant cache;
issuing, by the multi-tenant cache, a validation request to an authorization service;
receiving, by the multi-tenant cache, a result of the validation request;
responsive to determining the result of the validation request is a valid verification, performing the operation on the multi-tenant cache; and
issuing, by the multi-tenant cache and to the web-based client, a response to the first request.

9. The non-transitory machine-readable medium of claim 8, wherein the validation request includes a hash-based signature of credentials, a tenant identification (ID), and an application ID.

10. The non-transitory machine-readable medium of claim 8, wherein the first request includes a hash-based signature of credentials, a tenant identification (ID), an application ID, a session ID, and a payload for an application associated with the application ID.

11. The non-transitory machine-readable medium of claim 8, wherein the multi-tenant cache is indexed by a triplet including application identification (ID), tenant ID, and session ID.

12. The non-transitory machine-readable medium of claim 8, wherein the multi-tenant cache issues the validation request to the authorization service for every request received at the multi-tenant cache.

13. The non-transitory machine-readable medium of claim 8, wherein the response includes the web session data for the web session uniquely identified by an application identification (ID), tenant ID, and session ID.

14. The non-transitory machine-readable medium of claim 8, wherein the operations further comprise, before receiving the first request, receiving, at a web-based client, a request to re-initiate a web session that was previously disconnected.

15. A system for web session caching, the system comprising:
a web-based client configured to issue a first request to perform an operation on web session data; and
a multi-tenant cache configured to:
receive the first request;
issue a validation request to an authorization service;
receive, from the authorization service, a result of the validation request;
responsive to determining the result of the validation request is a valid verification, performing the operation on the web session data; and
issue to the web-based client, a response to the first request.

16. The system of claim 15, wherein the validation request includes a hash-based signature of credentials, a tenant identification (ID), and an application ID.

17. The system of claim 15, wherein the first request includes a hash-based signature of credentials, a tenant identification (ID), an application ID, a session ID, and a payload for an application associated with the application ID.

18. The system of claim 15, wherein the multi-tenant cache is indexed by a triplet including application identification (ID), tenant ID, and session ID.

19. The system of claim 15, wherein the multi-tenant cache issues the validation request to the authorization service for every request received at the multi-tenant cache.

20. The system of claim 15, wherein the response includes the web session data for the web session uniquely identified by an application identification (ID), tenant ID, and session ID.
